(19) United States
(12) Patent Application Publication
(10) Pub. No.: US 2013/0320933 A1
(43) Pub. Date: Dec. 5, 2013

(54) ELECTRONIC DEVICE

(71) Applicants: HAI-DONG TANG, Shenzhen (CN); KUO-PIN LIN, New Taipei (TW)

(72) Inventors: HAI-DONG TANG, Shenzhen (CN); KUO-PIN LIN, New Taipei (TW)

(21) Appl. No.: 13/677,333

(22) Filed: Nov. 15, 2012

(30) Foreign Application Priority Data
Jun. 5, 2012 (CN) 201210181633.8

(51) Int. Cl. H02J 7/00

(52) U.S. Cl. CPC H02J 7/0052
USPC 320/162; 320/137

(57) ABSTRACT

An electronic device receives a voltage from a power source. The electronic device comprises a voltage converting module, an energy storing module, a switching module, and an illuminating module. The voltage converting module converts the voltage provided by the power source into a working voltage. The energy storing module is capable of being charged by the working voltage. The switching module is connected between the voltage converting module and the illuminating module. The illuminating module is capable of emitting light for indicating the voltage of the energy storing module. When the working voltage is suddenly changed, the switching module turns off and cuts off an electrical connection between the voltage converting module and the illuminating module. The illuminating module stops emitting light.

### BACKGROUND

1. Technical Field

The present disclosure relates to electronic devices, and particularly relates to an electronic device with power indicating function.

2. Description of Related Art

Electronic devices, such as DVD players, include an internal battery, a micro control unit (MCU) and a light emitted diode (LED). The LED is used for indicating the capacity of the internal battery. In many electronic devices, the LED is directly connected to the external power source. When an electronic device is being powered by an adapter, the internal battery is also charged by the adapter. The MCU detects whether the charging status of the internal battery and generates a control signal to the LED. The LED emits light for indicating the status of the internal battery based on the control signal and the voltage of the adapter. However, if the voltage of the adapter suddenly spikes, the LED may be destroyed or damaged by the sudden increased in voltage.

Therefore, there is room for improvement in the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout two views.

FIG. 1 is a block diagram of an electronic device in accordance with one embodiment.

FIG. 2 is a circuit diagram of the electronic device of FIG. 1 in accordance with one embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at “least one”.

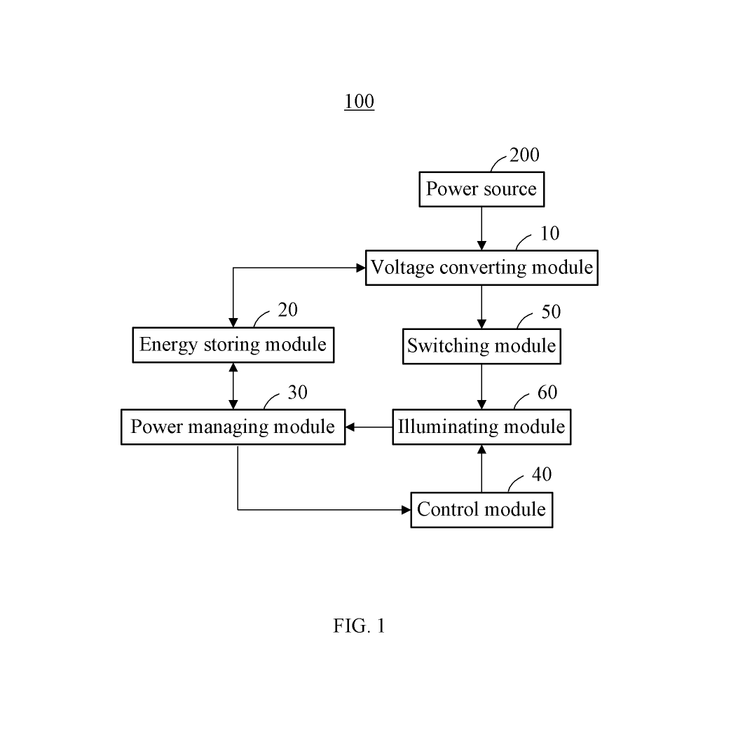

FIG. 1 shows an electronic device 100 of one embodiment of the present disclosure. The electronic device 100 receives a voltage from a power source 200 connected with the electronic device 100. The electronic device 100 includes a voltage converting module 10, an energy storing module 20, a power managing module 30, a control circuit 40, a switching module 50, and an illuminating module 60. The illuminating module 60 indicates a power of the energy storing module 20. In the embodiment, the electronic device 100 can be a mobile phone or a personal data assistant (PDA), for example; the power source 200 can be an adapter.

The voltage converting module 10 connects to the energy storing module 20 and the switching module 50. The voltage converting module 10 converts the voltage provided by the power source 200 into a working voltage and outputs the working voltage to the switching module 50 and the energy storing module 20. The voltage converting module 10 further can convert a voltage provided by the energy storing module 20 into the working voltage.

The energy storing module 20 connects to the voltage converting module 10 and the power managing module 30. The energy storing module 20 is capable of being charged by the working voltage when the electronic device 100 connects to the power source 200. The energy storing module 20 further provides a voltage to the voltage converting module 10 when the electronic device 100 disconnects with the power source 200. In the embodiment, the energy storing module 20 is an internal battery.

The power managing module 30 connects to the energy storing module 20 and the control module 40. The power managing module 30 detects the voltage of the energy storing module 20 and outputs the detected voltage to the control module 40.

The control module 40 connects to the power managing module 30 and the illuminating module 60. The control mode 40 generates a first control signal when the detected voltage is less than a predetermined voltage and generates a second control signal when the detected voltage is equal or larger than the predetermined voltage. In the embodiment, the first control signal is a logic high level signal and the second control signal is a logic low level signal; the predetermined voltage is equal to the maximum voltage provided by the energy storing module 20. In the other embodiment, the predetermined voltage is a minimum voltage provided by the energy storing module 20.

The switching module 50 connects to the voltage converting module 10 and the illuminating module 60. The switching module 50 turns on based on the working voltage and establishes an electrical connection between the voltage converting module 10 and the illuminating module 60. The switching module 50 turns off when the working voltage is suddenly increased and cuts off the electrical connection between the voltage converting module 10 and the illuminating module 60.

The illuminating module 60 connects to the power managing module 30, the control module 40, and the switching module 50. The illuminating module 60 emits light based on the first control signal and the working voltage. The illuminating module 60 stops emitting light when not receiving the working voltage or in response to the second control signal.

In other embodiment, the energy storing module 20 is being charged and generates a status signal to the power managing module 30. The energy storing module 20 further stops generating a status signal to the power managing module 30 when the energy storing module 20 is not being charged. The power managing module 30 controls the control module 40 to generate the first control signal in response to the status signal, and controls the control module 40 to generate the second control signal without the status signal.

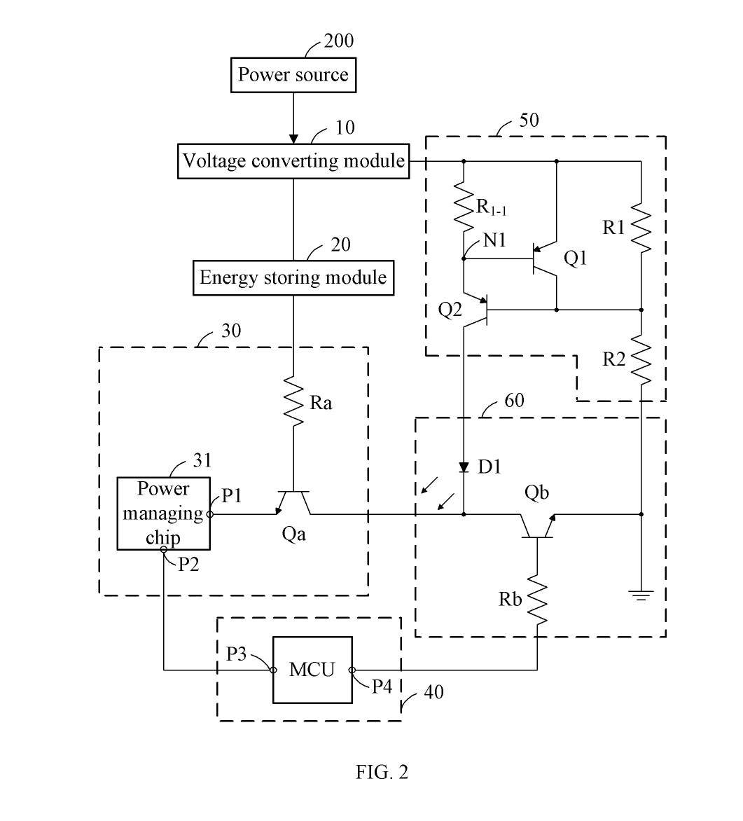

FIG. 2 shows the power managing module 30 of the embodiment. The power managing module 30 includes a power managing chip 31, a first switching transistor Qa, and a protecting resistor Ra. The power managing chip 31 includes a detecting pin P1 and a first control pin P2. A base of the first switching transistor Qa is connected to the energy storing module 20 through the first protecting resistor Ra. An emitter of the first switching transistor Qa is connected to the detecting pin P1. A collector of the first switching transistor Qa is connected to the illuminating module 60. In the embodiment, the first switching transistor Qa is an npn type bipolar junction transistor.

The control module 40 includes an input pin P3 and a second control pin P4. The input pin P3 is connected to the first control pin P2. The second control pin P4 is connected to the illuminating module 60. In the embodiment, the control module 40 is a MCU.

The switching module 50 includes a first transistor Q1, a second transistor Q2, a current limiting resistor R₁₋₁, a first resistor R1, a second resistor R2, and a first node N1. A base of the first transistor Q1 is connected to the voltage converting module 10 through the first node N1 and the current limiting resistor R₁₋₁ in that order. An emitter of the first transistor Q1 is connected to the voltage converting module 10. A collector of the first transistor Q1 is grounded through the second resistor R2. A base of the second transistor Q2 is connected to the collector of the first transistor Q1. An emitter of the second transistor Q2 is connected to the base of the first transistor Q1. A collector of the second transistor Q2 is connected to the illuminating module 60. An end of the first resistor R1 is connected to the emitter of the first transistor Q1, and the other end of the first resistor R1 is connected to the collector of the first transistor Q1. In the embodiment, both of the first transistor Q1 and the second transistor Q2 are pnp type bipolar junction transistor.

The illuminating module 60 includes a light-emitting diode D1, a second switching transistor Qb, and a second protecting resistor Rb. An anode of the light-emitting diode D1 is connected to the collector of the first switching transistor Qa, and a cathode of the light-emitting diode D1 is connected to the collector of the second transistor Q2. A base of the second switching transistor Qb is connected to the second control pin P4 through the second protecting resistor Rb. An emitter of the second switching transistor Qb is grounded. A collector of the second switching transistor Q2 connected to the cathode of the light-emitting diode D1. In the embodiment, the second switching transistor Q2 is an npn type bipolar junction transistor.

When electronic device 100 connects with the power source 200, the voltage converting module 10 outputs the working voltage to the energy storing module 20 and the switching module 50. The difference in voltage between the base and the emitter of the first transistor Q1 is almost 0V, the first transistor Q1 turns off. The first resistor R1 and the second resistor R2 form a discharging path from the voltage converting module 10 to ground. The voltage at the base of the second voltage is equal to the voltage divided by the first resistor R1 and the second transistor R2. The difference in voltage between the base and the emitter of the second transistor Q2 is less than 0V, the second transistor Q2 turns on. The light-emitting diode D1 emits light.

When the working voltage is suddenly increased, the voltage at the emitter of the first transistor Q1 is suddenly increased and the difference in voltage between the base and the emitter of the first transistor Q1 is less than 0V, the first transistor Q1 turns on. The voltage at the base of the second transistor Q2 is pulled up and the difference in voltage between the base and the emitter of the transistor Q2 is almost 0V, the second transistor Q2 turns off. The light-emitting diode D1 stops emitting light.

As described, when the working voltage provided by the power source 200 is suddenly increased, the switching module 50 turns off to cut off the electrical connection between the power source 200 and the illuminating module 60 and circuitry or circuitries of the electronic device is/are prevented from being destroyed or damaged.

It is to be understood, however, that even though information and advantages of the present embodiments have been set forth in the foregoing description, together with details of the structures and functions of the present embodiments, the disclosure is illustrative only; and that changes may be made in detail, especially in matters of shape, size, and arrangement of parts within the principles of the present embodiments to the full extent indicated by the broad general meaning of the terms in which the appended claims are expressed.

What is claimed is:

1. An electronic device receiving a voltage from a power source, the electronic device comprising:
a voltage converting module converting the voltage provided by the power source into a working voltage;
an energy storing module being charged by the working voltage;
a switching module connected to the voltage converting module and the illuminating module; and
an illuminating module capable of emitting light for indicating the energy storing module is being charged;
wherein when the working voltage is suddenly changed, the switching module turns off and cuts off an electrical connection between the voltage converting module and the illuminating module, the illuminating module is powered off and stop emitting light.

2. The electronic device of claim 1, wherein when the working voltage is in a normal status, the switching module turns on and establishes the electrical connection between the voltage converting module and the illuminating module; the illuminating module is powered by the working voltage.

3. The electronic device of claim 2, wherein the electronic device further comprises a power managing module and a control module; the power managing module detects the voltage of the energy storing module; the control module sends a first control signal to the illuminating module when the detected voltage is less than a predetermined voltage, the illuminating module emits light based on the working voltage and the first control signal.

4. The electronic device of claim 3, wherein when the detected voltage is larger than the predetermined voltage, the control module generates a second control signal and the illuminating module stops emitting light in response to the second control signal.

5. The electronic device of claim 3, wherein the predetermined voltage is equal to the maximum voltage provided by the energy storing module.

6. The electronic device of claim 1, wherein the electronic device further comprises a power managing module and a control module; when the illuminating module is powered by the working voltage and energy storing module is being charged, the energy storing module generates a status signal to the power managing module, the power managing module controls the control module to generates a first control signal in response to the status signal, the illuminating module emits light in response to the first control signal.

7. The electronic device of claim 6, wherein when the charging operation of the energy storing module is completed, the energy module stops generating the status signal, the power managing module controls the control module to generate a second control signal without receiving the status signal, the illuminating module stops emitting light in response to the second control module.

8. The electronic device of claim 1, wherein the switching module comprises a first transistor, a second transistor, a current limiting resistor, a first resistor, and a second resistor; the first resistor and the second resistor are connected between the voltage converting module and ground in series; a base of the first transistor is connected to the voltage converting module through the limiting resistor, an emitter of first transistor is connected to the voltage converting module, a collector of the first transistor is connected between the first resistor and the second resistor; a base of the second transistor is connected to the collector of the first transistor, an emitter of the second transistor is connected to the base of the first transistor, a collector of the second transistor is connected to the illuminating module.

9. The electronic device of claim 2, wherein the power managing module comprises a power managing chip and a first switching transistor; the power managing chip comprises a first pin and a second pin; a base of the first switching transistor is connected to the energy storing module, an emitter of the first switching transistor is connected to the first pin, a collector of the first switching transistor is connected to the illuminating module; the second pin is connected to the control module.

10. The electronic device of claim 1, wherein the illuminating module comprises a light-emitting diode and a second switching transistor; the control module comprises a third pin and a fourth pin; the third pin is connected to the power managing module; the fourth pin is connected to a base of the second switching transistor, an emitter of the second switching transistor is grounded, a collector of the second switching transistor is connected to a cathode of the light-emitting diode, an anode of the light-emitting diode is connected to the switching module.

11. A switching circuit, comprising:
a voltage converting module generating a working voltage;
an energy storing module being charged by the working voltage;
a switching module connected between the voltage converting module and the illuminating module; and
an illuminating module capable of emitting light for indicating the energy storing module is being charged;
wherein when the working voltage is suddenly changed, the switching module turns off and cuts off an electrical connection between the voltage converting module and the illuminating module, the illuminating module is powered off and stops generating light.

12. The switching circuit of claim 11, wherein when the working voltage is in a normal status, the switching module turns on and establishes the electrical connection between the voltage converting module and the illuminating module; the illuminating module is powered by the working voltage.

13. The switching circuit of claim 11, wherein the switching circuit further comprises a power managing module and a control module; the power managing module detects the voltage of the energy storing module; the control module sends a first control signal to the illuminating module when the detected voltage is less than a predetermined voltage, the illuminating module emits light based on the working voltage and the first control signal.

14. The switching circuit of claim 13, wherein when the detected voltage is larger than the predetermined voltage, the control module generates a second control signal and the illuminating module stops emitting light in response to the second control signal.

15. The switching circuit of claim 13, wherein the predetermined voltage is equal to the maximum voltage provided by the energy storing module.

16. The switching circuit of claim 11, wherein the switching circuit further comprises a power managing module and a control module; when the illuminating module is powered by the working voltage and energy storing module is being charged, the energy storing module generates a status signal to the power managing module, the power managing module controls the control module to generates a first control signal in response to the status signal, the illuminating module emits light in response to the first control signal.

17. The switching circuit of claim 16, wherein when the charging operation of the energy storing module is completed, the energy module stops generating the status signal, the power managing module controls the control module to generate a second control signal without receiving the status signal, the illuminating module stops emitting light in response to the second control module.

18. The switching circuit of claim 11, wherein the switching module comprises a first transistor, a second transistor, a current limiting resistor, a first resistor, and a second resistor; the first resistor and the second resistor are connected between the voltage converting module and ground in series; a base of the first transistor is connected to the voltage converting module through the limiting resistor, an emitter of first transistor is connected to the voltage converting module, a collector of the first transistor is connected between the first resistor and the second resistor; a base of the second transistor is connected to the collector of the first transistor, an emitter of the second transistor is connected to the base of the first transistor, a collector of the second transistor is connected to the illuminating module.

19. The switching circuit of claim 13, wherein the power managing module comprises a power managing chip and a first switching transistor; the power managing chip comprises a first pin and a second pin; a base of the first switching transistor is connected to the energy storing module, an emitter of the first switching transistor is connected to the first pin, a collector of the first switching transistor is connected to the illuminating module; the second pin is connected to the control module.

20. The switching circuit of claim 11, wherein the illuminating module comprises a light-emitting diode and a second switching transistor; the control module comprises a third pin and a fourth pin; the third pin is connected to the power managing module; the fourth pin is connected to a base of the second switching transistor, an emitter of the second switching transistor is grounded, a collector of the second switching transistor is connected to a cathode of the light-emitting diode, an anode of the light-emitting diode is connected to the switching module.
